(19) United States
(12) Patent Application Publication
(10) Pub. No.: US 2007/0094077 A1
(43) Pub. Date: Apr. 26, 2007

(54) Guiding system for producing presentation folders

(76) Inventors: Holm Hallbauer, Dresden (DE); Mark Hallbauer, Dresden (DE)

Correspondence Address: KNOBBE MARTENS OLSON & BEAR LLP, 2040 MAIN STREET, FOURTEENTH FLOOR, IRVINE, CA, 92614, US

(21) Appl. No.: 11/479,987

(22) Filed: Jun. 29, 2006

Related U.S. Application Data
(63) Continuation-in-part of application No. 11/342,325, filed on Jan. 27, 2006.

(30) Foreign Application Priority Data
Oct. 20, 2005 (DE) 10 2005 050 355.1

(51) Int. Cl. G07G 1/14

(52) U.S. Cl. 705/14

(57) ABSTRACT

The present invention relates to a guiding system for producing presentation folders comprising an information processing unit, an information collection unit, a storage unit, a first printing unit, a communication unit and a handwriting and position detection device, wherein the information processing unit has a communication channel to the handwriting and position detection device via the communication unit. The invention hereby addresses the task of enabling the manually infeasible automated production of individualized printed products per target customer in large quantity, as used in particular in the selling of telephone directory ads. The present invention relates also to an associated method for producing presentation folders.

### CROSS REFERENCE TO RELATED APPLICATIONS

This application is a continuation-in-part of U.S. application Ser. No. 11/342,325, filed Jan. 27, 2006.

### BACKGROUND

The present invention relates to a guiding system for producing presentation folders using an information processing unit, an information collection unit, an information storage unit, a first printing unit, a communication unit and a handwriting and position detection unit. The present invention is also related to a method of producing presentation folders by analyzing customer-relevant data utilizing machine learning.

When printing telephone directories, in particular those which are known as business directories (yellow pages), the question of advertisement size and content arises each year or at each new updating cycle of determining the entry dimensions for company purchasing an entry. Business directories contain an alphabetical listing of companies along with their address and telephone number, or a listing according to a different sorting criterion, for example thematic sorting. Entries can be a simple single-line entry, or can be an elaborately designed ad-like entry containing not only basic information such as company name, address and telephone numbers but also a wide spectrum of additional information. Such additional information usually concerns products or services offered. Ad-like entries in business directories can thus have considerable advertising effect for the respective company, including contributing to its branding. For example, a relatively small company can draw distinctive attention with a disproportionately large entry in a business directory. In contrast, a single-line entry for a large and well-known company can be quite damaging to its branding. It is important to realize in this context that the Internet and the marketing and advertising opportunities it offers have given rise to a development which threatens to radically undermine the traditional advertising mechanisms of business directories. The business directory industry is thus up against a classic situation of “disruptive technology,” against which the industry needs to develop the appropriate defense strategy.

The following will treat the terms “advertisement” and “business directory entry” and “telephone directory entry” as synonymous.

So as to optimize sales and profits, telephone directory companies are additionally desirous of receiving preferably large-format ads and entries from each company for inclusion in its telephone directory. It is thereby the task of a telephone directory salesperson to sell a preferably large ad or entry to each company listed in his/her respective business directory. Since most areas (geographical or thematic) have several competitive business directories while business telephone customers only have a limited budget to spend on telephone book advertisements, each telephone directory publisher strives to get the respectively largest number of large ads in its business directory.

The sales process mentioned above follows the rules of traditional selling, whereby for all purposes, none of the salespeople from the various different telephone directory publishers has any palpable advantage over the others. Typical sales aids are hereby glossy brochures of the respective telephone directory publishers and, in the best case scenario, traditional business letter sized flip charts which can be set up on a table and flipped through. Some telephone directory publishers have also tried equipping their sales reps with laptop computers and the respective presentations. Yet the salespeople are usually more encumbered than supported by the technology. The customer's attention is directed to the technical equipment and the salesperson's full attention to the customer is lost. Additionally, there are no sales aids known at present which support the unique, specific situation of an individual customer in bulk sales such as telephone directory ad sales.

### SUMMARY

Explicit reference is made to this applicant's “Sales Aid” application PCT/EP2006/000416, the contents of which are to be regarded as being explicitly included here by reference.

The problem which the present invention addresses is the enabling of automated mass-production of individual printed products per target person, which would be manually infeasible to produce, as used in particular when selling space in telephone directories.

This task is solved by the guiding system for producing presentation folders according to claim 1, a method for producing presentation folders according to claim 13, as well as the computer program product according to claim 27 and a computer readable medium according to claim 28.

What is essentially involved in terms of the presentation folders are printed sales aids for salespeople selling advertisements. The folders have a unique geometric shape which is explained in more detail in the above mentioned patent application PCT/EP2006/000416. It is filled with text and images on an individual case basis. In this context, target person-relevant data refers to what is compiled specifically for a particular person. The term “machine learning” is to be understood in this context as a self-optimizing process for the method, which generates continually better results upon each new cycle based on adaptive changes made with respect to specific valuation criteria. A result is better when there is a higher probability of making an ad sale or if higher individual or total sales can be achieved.

The guiding system for producing presentation folders comprises an information processing unit, an information collection unit connected to said information processing unit for collecting data from at least one source, an information storage unit connected to said information processing unit for storing collected and processed information, a first printing unit connected to said information processing unit, a communication unit connected to said information processing unit and a handwriting and position detection device, wherein the information processing unit has a communication channel to the handwriting and position detection device via the communication unit. By this communication link changes on the presentation folder can directly be transmitted to a computing center for further processing or evaluation. The first printing unit is arranged for large volume printing of presentation folders.

A terminal connected to the guiding system serves as input output device for programmers and end users. The terminal can be any network attached communication device.

The connection between the computing center and the handwriting and position detection device can be done via a mobile network supported by a mobile communication unit which can be a mobile phone.

The mobile communication unit can be included or supported by an electronic device such as a personal digital assistant (PDA). It can also be a smart phone that has communication and computing capabilities. It helps the user of the system to carry only one device instead of many. Updated visit schedules for the user can be downloaded directly to this combination device.

There is also provided a second printing device that is connectable to the mobile communication unit. The communication link could be wireless or cable based. It enables the user to remotely print a document from the data computer center during a meeting with another person.

A global positioning system (GPS) expands the options available for the guiding system. It has city maps stored and it can direct the user from one location to another optimizing the route taken. A displayed set of directions and potentially voice commands direct the user to the desired location. It can also free the user to care about road blocks, traffic jam etc. Routes can be planned and optimized automatically. If another optimized route has been calculated in the computing center all new route information can be send to the global positioning system. Another advantage of an integrated global positioning system is a direct controlling and evaluation of a sales person's activities or routes taken by his management. Still another advantage is that during a campaign the routes for the sales persons can be updates “on the fly”, i.e.: when the sales person is en route. He does not need to pick up another route plan or other instructions in order to follow new instructions. Even phone calls and the requirement to take notes can be eliminated. The global positioning system can be integrated into the mobile communication unit or the cell phone or a combined device of cell phone and personal digital assistant.

The handwriting and position detection device is capable of detecting its position and other data printing as background pixel marks on the presentation folders. The presentation folders can thus be changed with handwritten text or drawings that can be captured by the handwriting and position detection device. No other manual input by means of a keyboard is required. The link from the handwriting and position detection device to the computing center could be established directly or via the mobile communication device that serves as a local communication enter with links to the GPS, the second printing unit and the handwriting and position detection device.

The particular advantage of the inventive method is that a large volume of individualized data is collected and evaluated individually and collectively such that a large number of individualized printed products—in particular presentation folder—can be produced for various different target persons of target customers. Manual production of a large number of presentation folders within one campaign is prohibitive for reasons of volume. For this reason, standardized presentation folders—i.e., identical for each customer have always been used in the past. It is well-documented that generalized presentation folders are far less successful than those prepared individually for a specific target person. Also, manual methods do principally not allow automated self-optimizing or machine learning so as to achieve better results; i.e., a higher probability of closing a sale or higher revenues in sequential sales campaigns where the identical procedure is re-used each time.

Other industry sectors can also make use of the inventive method such as the insurance industry in selling of insurance policies or banks in the selling of financial investment or annuity products. Generally speaking, the inventive method can be utilized wherever a customizable product or a customizable service is being sold to a target person on an individual basis within the scope of a larger sales campaign. This could also be the case for campaign for selling advertisements for the Internet or the World Wide Web (e.g.: Google or other search engines). A typical sales campaign in this regard lasts about six weeks. A campaign is characterized by determining a target customer group, addressing the selected target customers with promotional materials and ultimately evaluating the results. Not all industry sectors commonly include pre- and post-processing stages—i.e. target customer selection and follow-up—in their campaign periods. In these cases, a campaign can also be longer. On the other hand, there are also micro-campaigns in which the advertising measures are applicable only for a few days, sometimes even only a few hours. Traditional customer selection procedures as well as the contact and evaluation will then be completely thwarted. Even with campaigns lasting six weeks, manual procedures are thoroughly overtaxed and practically impossible.

The process step of “evaluating individualized data” also encompasses forming at least one prototype class of model customers. Model customers in this sense are idealized customer types which emerge during the traditional sales process. The advantage to creating such prototype classes—by a classification algorithm—is in the fact that a larger number of individual customers can be mapped within these prototype classes such that when further processing the data, while the information can be individually related to a specific customer, is it also possible to subsequently achieve a more abstract processing based on the characteristics of the various classes. In this context, abstract processing refers to, for example, being able to treat whole groups of customers in a similar way. Hence, identical key control parameters (e.g. company sales, company type, previous ad sizes, special preferences, industry, etc.) control the execution of a next campaign step. Among other things, this can mean the usage of the same printing template to generate presentation folders customized to one specific target person. Printing templates in particular refer to master templates having the overall same layout yet which can be individually printed with content specific to the respective target person. This thus combines both the advantages of an utterly individualized aspect as well as the wholly traditional customer group-based approach. Total expenditures or cost of a campaign can hereby be optimized.

The mapping of individualized customer data to the prototype customer classes is hereby an N:1 process. In other words, the number of customers is typically greater than the number of prototype classes. The set of rules which forms the basis for the process, yet which can be modified at any time, is designed such that a certain combination of characteristics from the individualized customer data always leads to only one single prototype class. The ruleset governing the assigning of the individualized customer data to the individual prototype classes can be reformulated for each campaign. This even allows easy creation of ad campaigns for special events. For example, if a special event will be taking place in the catchment area of a retailer or service provider (e.g. a sporting event near a restaurant), a program guide can be printed explicitly for this event which also contains ads from local retailers or service providers. The following prototype class attributes to be incorporated when defining basic prototype classes are given as examples: Type: Restaurant; Type: Fan souvenir shop; Type: Pharmacy; Type: Taxi/Transportation company: Type: Hotel/Motel, as well as the geographical location. The versatile applicability here goes far beyond using the method as a basis for redesigning a business telephone directory and the related selling of ads. Creating other printed products with the inventive method is just as readily conceivable.

When collecting individualized data—in particular individualized target person-relevant data—both structured (e.g. sales, staff size, past ad sales; i.e., all information which can be depicted in precise numbers and terms) as well as unstructured data (includes images, photos, scanned ads; i.e., all information not constituting characteristic text/number information) is collected and stored in a database. Unstructured data here is basically that which is only available in the form of printed information, usually image-based information like a combination of image and text, e.g. scanned ads. Using a special text recognition program (based on OCR technology; OCR=optical character recognition), some structured data can be retrieved from the unstructured data in the form of text (e.g. company name, street and location information, email address, website, placement information), numbers (telephone number, actual address, etc.) as well as isolated image elements such as a company logo, for example. Structured data here are particularly those that can be processed in traditional data processing systems as a combination of numbers and characters mapped into the individual fields of a database system. All the data related to a potential customer can be clearly linked. This can be done, for example, through the associated telephone number or address and name of the company. Other abstract classification criteria will be known to those experts familiar with information processing. Thus, all different types of information are addressable using a unique access key.

A plurality of information sources is conceivable as data sources for the structured and unstructured data. Apart from the structured/unstructured dimension, data sources can also be divided into internal/external dimensions. Data and information sources thereby include: telephone/business directories—in particular past directories from the same or competitive publishers, industry data (also localized and geographically-classified marketing data) obtainable from special industry service providers, the historical data of a target company, activity-based data, competitor data, in particular the telephone directory ads of competitors, company indicators, financial/credit rating data and/or past ad sales, time-related data such as seasonal sales for a sub-branch, natural catastrophe information (which generates a specific demand for certain services such as, e.g. renovation), etc. Of course, all combinations of information are conceivable. Being able to take all these different sources of data and information into consideration has the advantage that a customer's need for an ad can be predicted with a high degree of probability. The art of the campaign designer lies in determining which information/data sources will be used for a specific campaign. Should the company to be approached be struggling with financial difficulties, the individualized printed product (customer presentation folder) can feature an ad proposal which is more reflective of a lower budget. On the other hand, it is also conceivable to propose an especially large ad to a company which is financially strapped, which sends out the signal that the company is doing above-average financially—in direct contrast to the actual situation. The actual ad proposal made follows from the ruleset on which the prototype class assignment is based and is normally correlated with the conventions of the geographic area and industry.

The advantage of using a combination of structured and unstructured data from print as well as electronic media is that the sum total of information available from a target customer is maximized.

The printed product resulting from the inventive method does not consist of a sequence of standard printed pages, but rather of a special geometrically-formed presentation folder which is designed such that the manner in which the individual pages are folded leads the folder as well as the presenting person and also the target person through a sales pitch in structured fashion. In so doing, information which is intended only for the salesperson is printed so that only he/she can read it, for instance because it appears “upside-down” to the customer, while customer-relevant information is printed so that it's easy for the potential customer to read and appears “upside-down” to the salesperson when the customer and salesperson are sitting directly across from one another, as is the usual case.

The printed information in the presentation folder is hereby in particular designed such that the specific individual customer situation can be directly addressed, whereby the information printed on the presentation folder can be optimized according to variable rules based on the evaluation of the information as well as the available space. This thus advantageously ensures that the customer is not approached with a standard product or a standard sales aid but rather his/her entire situation is taken into consideration.

In particular, the presentation folder presents two alternative proposal scenarios in the form of two different ad sizes. This ensues from the printing being associated with printing templates such that the salesperson initially opens the sales meeting with the larger format ad. The smaller format ad proposal is thereby printed on the reverse side of the presentation folder and is not visible until a page of the presentation folder is turned following the customer rejecting the main offer of the larger format ad. This set-up radically increases the probability of a successful sale. Further provided is that not only one presentation folder can be generated per customer but rather several different presentation folders can be created for each target customer. The salesperson then has a choice of which to use during the actual sales pitch based on his/her individual preferences.

The method according to the invention furthermore provides for acquiring success parameters from the sales process. Hereto, the method draws on information on the use of individualized printed products and/or sales aids as feedback information which can then be integrated into the next use of the method during the evaluation process, which serves the creation of an evaluation. Success parameters in this case are to be understood as information on closing an ad sale based on a specific customer brochure, individual sales, as well as other parameters assigned to a pre-defined campaign. The advantage of recovering this information is that the self-optimizing learning process can now be initiated. Parameter feedback enables statements to be made on the success of certain types of individualized printed products and/or sales aids. Correlations can thereby be made on diverse counts, conceivably including: company size-ad size, staff size-ad size, salesperson type-ad size, regional economic situation-discount level, salesperson type-discount level. These correlations are to be understood as examples of virtually any other correlation analysis. Also conceivable is correlating the parameters to a presentation folder based on a pre-defined template, from which a salesperson can have several per customer.

After a number of sales campaigns have run successively using the method according to the invention, it becomes possible, when evaluating the individualized data, to draw conclusions from the historical course of the changing parameters and valuation criteria on the one hand and the sales revenues and changes in sales on the other, with respect to particularly favorable sets of parameters. It is additionally possible to change the parameters based on the information obtained so as to increase the probability of success. To analyze the parameters and feed this information back into the rulesets for the evaluation and creation of the individualized printed products, one skilled in the art can make use of known procedures such as case base reasoning, decision tree models or even cluster analyses and statistical variance analyses.

In another preferred embodiment, two further steps are additionally provided. One involves using a special pen (handwriting and position detection device) to acquire changed or additional individualized data on the presentation folder. The pen recognizes additions made and stores them in the pen. Forwarding of the newly-acquired information to the evaluation step performed on the individualized data then follows. Alternatively, forwarding can also be to the step of creating the individualized printed products. A plurality of alternatives from the field of transmission technology can be used for the path of transmission. Explicit reference is made to the following: the pen transmits the information via a short-range means of communication (e.g. Bluetooth, infrared or even wired) to a mobile communication device (e.g. a cellular phone or a wireless-enabled PDA (personal digital assistant)) or to another communication-ready device. The information is routed from there to the evaluation step on the individualized data or to the printing step on the individualized data. A new analysis of new data values can now advantageously ensue. At least one such data value can be a new advertisement price or another contractual condition.

It is also possible to have an online check of the advertisement that has been changed during the discussion of different options. The method would be the following. The changes are stored in the pen during the discussion. At the end or at a checkpoint in the discussion the information is transferred from the pen to the mobile communication device which communicated the information directly to the central part of the guiding system in the computing center as described above. Because the proposal for a new advertisement has been generated in the computing center as part of the production of the presentation folder all information is now again electronically available. A chief editor being alerted by the reception of the changed advertisement could immediately review the changes and could confirm that the changes are technically or price-wise possible. However, this manual step is not required it is an option. An automated process could also instead calculate a new price.

However, one key advantage of this method is that all information is available electronically. None of the changes made to the advertisements proposal have to be redone for a printing process. This way the complete generation of business directories can be streamlines enormously.

It is particularly preferred for the step of acquisition (and recognition) of information to be based on pixel information which is printed as a background on the individualized printed product and is only identifiable to the naked eye as a gray background coloring. As such, the paper is all but given interactive properties. The pen immediately and electronically records supplementing information upon changes being made to the presentation folders. This wholly does away with the need for manual transfer at a computer terminal and the entire process runs substantially more elegantly, faster, and far less susceptible to errors.

The at least one new data value generated is then advantageously forwarded via a mobile communications network to a portable means of communication where it is ultimately depicted on the ad for the user's further use. A plurality of purely numerical or alpha-numerical characters can also be transmitted. By so doing, the salesperson is enabled to convert the new information received during the discussion with his customer into a new offer while still in the middle of his/her sales pitch, one which is not based on his or her own estimations but rather on a confirmed revaluation drawing on all data available to the company. This thus eliminates discounts which are too high and the accompanying slump in results or individual conditions based solely on the speculation of a single person. Hence, a technically closed loop system is realized, one which has previously not been feasible in such a way.

Lastly, the task on which the invention is based is solved by a computer program product. This computer program product serves the realization of the inventive method on the inventive guiding system, which is what makes the inventive method viable in the first place given the limited time frame available for campaigns. The computer program product is typically stored on a computer readable medium

### BRIEF DESCRIPTION OF THE DRAWINGS

The invention will be described in the following by illustrative embodiments which make further descriptive reference to the drawings. Shown are:

FIG. 1 a diagram of key components of an embodiment of the guiding system according to one aspect of the invention;

FIG. 2 a general view of the method according to the invention;

FIG. 3 a partial process of an embodiment for producing individualized printed products;

FIG. 4 a further partial process of the inventive method for generating the customer classes;

FIG. 5 a further partial process of assigning the individualized customer data to customer classes for a further embodiment;

FIG. 6 the use of the optimizing process as part of an embodiment; and

FIG. 7 a preferred embodiment of the inventive method in which data are recorded on the presentation folder as well as at least one data value being transmitted back to a portable communication device.

### DETAILED DESCRIPTION

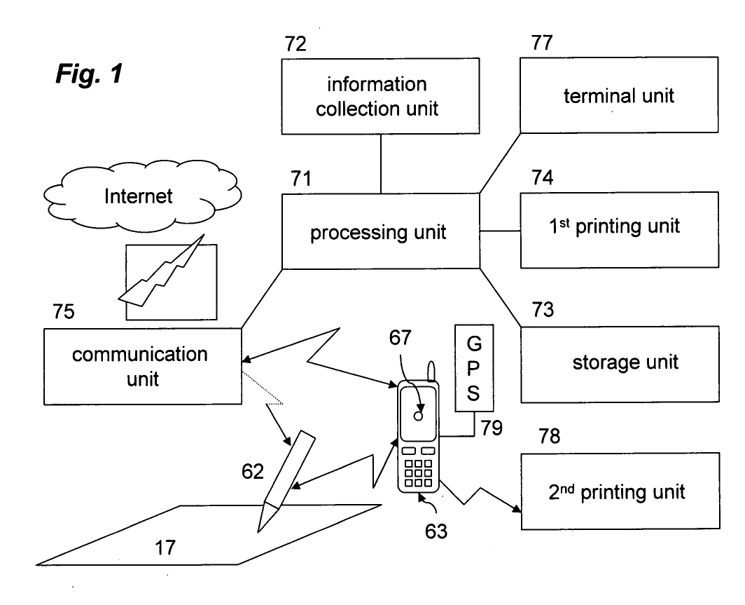

FIG. 1 is an overview diagram of the key components of one embodiments of the inventive guiding system. In the middle a processing unit 71 controls the usage of other resources and the way they are used and involved. It could be a general purpose central processing unit of a computer system with all necessary supporting devices such as read-only-memory, random-access-memory, timing controls and data and address busses. Connected is a storage unit 73 for storing program and application data such as an operating system, a database or an application program that could control a sales and marketing campaign. Another storable element could be a database for structured and/or unstructured data containing for example individualized data relating to a sales and/or marketing campaign. These data could have been transferred to the database from the information collection unit 72. This information collection unit collects relevant data for a planned campaign from various sources 13. The information collection could be made via the Internet, via special databases, via an electronic scanner (not shown) that is connected to the information collecting unit 72 and that scans relevant documents, e.g.: older telephone directories, company brochures or annual reports. The information is transferred directly from the information collection unit 72 to the storage unit 73 or with the support of the processing unit 71. It could be possible that the information collection unit 72 makes use of the communication unit 75 and connects directly to the Internet or other similar information pools using a search engine for finding and collecting required information. All information collected can be grouped in order to establish an information pool focusing on a special target person.

A terminal unit 77 serves as a user interaction device. Typically it is equipped with a keyboard and a display. It can be used by system programmers modifying computing rules or by an end user keying in e.g.: success parameters of an action taken. Typically a system as discussed has more than one terminal unit 77 used by different individuals. The terminal unit can also be connected via a remote access mechanism such as a LAN (local area network) or a mobile connection. The specific type of terminal is not particular relevant to this inventive system. The units discussed so far—apart from the data sources 13—are typically located relatively close together, i.e.: in a computing center.

In addition there is provided a first printing unit 74. This first printing unit 74 can print individual presentation folders 17 used in a campaign. These folders have a certain design as explained later. The first printing unit 73 is also capable of printing special background pixel marks onto printable material like presentation folders 17. These marks serve later for the position detection of a handwriting and position location device 62.

In addition, a mobile communication unit 63 is part of the system. It has a display 67 for displaying information about the operational status of the communication unit 63 or other received information. The mobile communication device 63 could be a mobile phone or cell phone. It could also be a personal digital assistant or a combination of both. It is required that it can communicated with the communication unit 75 in the computing center. Beside the mobile communication channels wire-line communication channels are also possible. In addition, the mobile communication unit 63 is equipped with communication capabilities to communicate to a handwriting and position detection device 62. The communication can be established via several communication standards, e.g. Blue Tooth, infrared, or other wireless communication protocols, or be wire-based. Alternatively, there could be a direct communication channel from the handwriting and position detection device 62 to the processing unit 71 via the communication unit 75 in the computing center.

Moreover, there is provided a global positioning system 79, e.g. GPS. Other global positioning systems are possible as long as the purpose of finding the correct position of the device relative to earth coordinates is guaranteed, e.g. the Galileo system. The global positioning system 79 is in communication contact to the mobile communication device 63. The mobile communication device 63 and the global positioning system could all be integrated into a general purpose personal assistance tool with a common display 67. The GPS 79 having stored city maps can display instructions to a user how to go to a desired location. It can also be integrated with the mobile communication unit 63, cell phone 63 and/or a personal digital assistant integrated into or connected to the cell phone 63.

There is also provided a second printing unit 78. It is in electronic communication with the mobile communication device 73. The second printing unit 78 is typically a mobile printer that can be carried around and may be independent of a power line. Beside other formats, it should be able to print business letter sized documents.

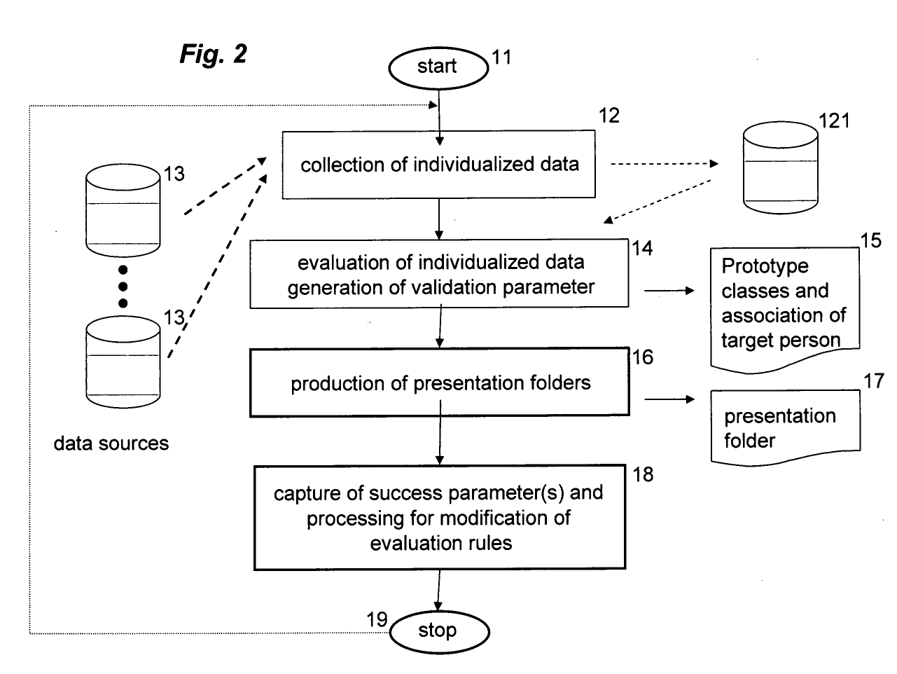

The basic operational sequence of the method is depicted in FIG. 2. Step 11 constitutes the start of a campaign. Individualized data on potential customers within a territory is collected in a database 121 in Step 12. The accumulating of data is derived from the various different electronic and non-electronic data sources 13. To this end, the non-electronic sources of data are scanned electronically and thus also made available electronically. Examples of non-electronic sources of data for Step 12 would be telephone directories from rival publishers and the ads they contain. All data related to one potential customer is individually addressable in database 121. Addressability can be a function of, for example, the telephone number of the potential customer or also company name together with the associated mailing address. The expert is familiar with this type of and other abstract addressing variants.

When processing unstructured sources of data, automatic recognition of the textual contents—e.g. using OCR—is conceivable. The larger the degree of detail and breadth to the data sources, the better presentation folder.

The following are examples of potential data source content: detailed data on potential customers such as a contact name, company size, product/service offering, targeted customer group, industry and sub-branch information, ad sales information of the potential customers over a historic period of time, revenue trends, realized advertising campaigns—in particular, information on current advertising, the layout, the type of ads, the color scheme, sizes, etc.—information about past complaints, information on the financial situation including credit history, a history of the contact person including personal preferences as well as affinity for certain products, the geographical reach of a company—in particular whether the company sells or has branch offices in other geographical regions, information on competitors such as for example names of direct competitors, their sales profile and advertising campaigns as well as the ad history of direct competitors; information about media data which competes with the telephone directory such as, for example, that from newspapers, radio, television, Internet and other media which the potential customer may use and also including, for example, spending profiles for such other media. It is moreover conceivable to incorporate general market information such as, for example, a business climate index which is broken down into individual industries or sub-sectors. This also relates to the economic efficiency of a specific advertising region, information on the prevailing unemployment rate, as well as evaluations of a specific potential ad for comparable customer classes. All of the above-cited detail parameters are to be regarded as examples. The fundamental concept encompasses gathering as much information as possible on a potential ad customer in database 121 automatically which can then be processed further during assessment steps and printing of a presentation folder.

Step 14 comprises evaluating the data collected in database 121 as well as generating evaluation parameters. This can be done, for example, using assessment factors for different classes of information in the database. The assessment rules can be defined externally and can also be reset for each sales campaign. Typically, an experienced campaign specialist will specify the rules for weighting the individual assessment parameters at the beginning of a campaign.

After an evaluation has been generated, in that the individualized data in database 121 have been assigned weighting parameters, Step 16 effects the production of presentation folders 17 having a plurality of different pages. Said presentation folders 17 are based on specific printing templates designed such that the type of information per presentation folder page is pre-defined. The templates also establish the general layout of the presentation folder. Based on the evaluation in Step 14, the template type is first selected and then the individual pages of presentation folder 17 are filled with the information from database 121. In doing so, the template defines which information is printed in which point within presentation folder 17. When there is more information per page or per area of the page than available printing space, the information which received the highest evaluation parameters in Step 14 is selected. One embodiment provides for one printed product per potential customer. In this first embodiment, Step 18 can also be skipped, in which case the method ends with Step 19.

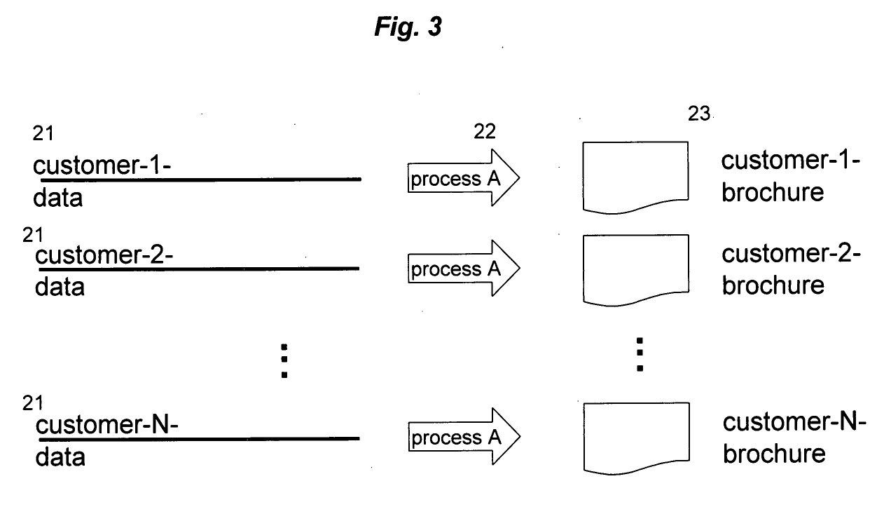

This discussed embodiment further provides for the individualized customer data in database 121 to be evaluated in a single processing step and to generate presentation folders 17 in the form of customer brochures 23 from same—as depicted in FIG. 3. For all purposes, evaluation step 14 and generating step 16 occur in one single logical process step, which is indicated by reference number 22 in FIG. 3 (“process A”). However, in the case of sizeable data (several thousand customers), it can happen that the externally-supplied valuation rules of Step 14 become very complex and there is then only little or even no provision for additional correlation between customer data and competitor information.

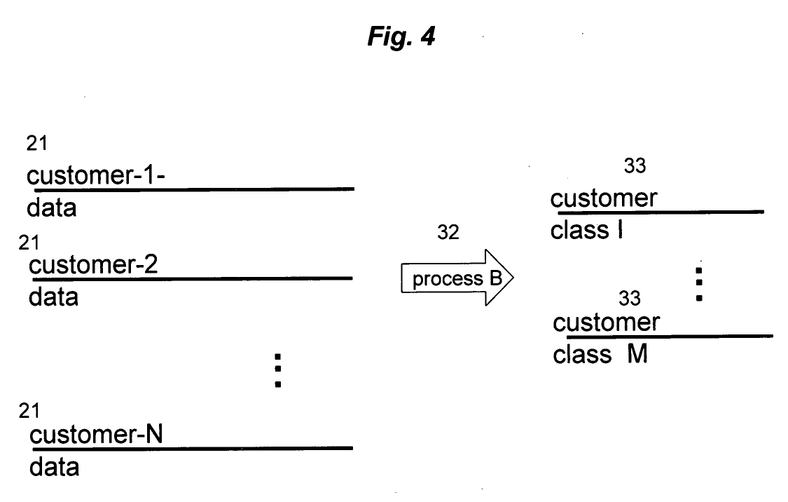

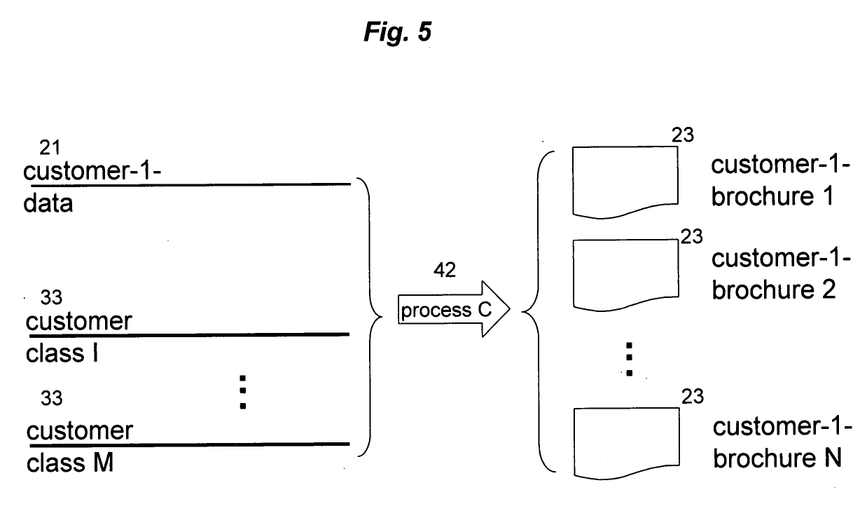

For this reason, a two-stage evaluation process is provided in the inventive method, as represented in FIGS. 4 and 5. First, typical customer classes 33 are created. These customer classes are formed based on, for example, customer size, the customer's industry sector, competitive environment, geographical information, etc. The rules for establishing customer classes I through M are individually configurable and can be redefined for each campaign. Particular deference in this regard is made to the expert knowledge of the campaign team. Yet this recourse to manual intervention is not imperative, it merely represents one option. Here the customer classes 33 are configured in such a manner than each instance of individualized customer data in database 121 can be assigned to one of customer classes I through M. A crucial point in this regard is that the number of customer classes is substantially smaller than the number of potential customers in database 121. Good results have been noted using about 100 customer classes. Although it is also conceivable to have a smaller number of customer classes. As a rule, the number of potential customers in database 121 to be mapped to these approximately 100 customer classes will amount to several thousand, although it may also comprise several million data records. If the relationship between customer classes and customer data changes the basic method itself does not change. The assigning of customer data 21 to the customer classes 33 is identified with reference numeral 32 (“process B”) in FIG. 4.

This partial process employed in the second embodiment, described above with respect to FIG. 4, is performed in Step 14 of FIG. 1. The prototype classes and the assigning of customer data 15 as a result of the evaluation can also be seen in FIG. 2. In the second embodiment, the generation 16 of presentation folders 17 occurs during the partial process depicted in FIG. 5. Same provides for the production of presentation folders 17, shown here as different customer brochures, and links the customer data, e.g. customer-1-data, with the relevant customer classes 33 and the printing templates associated with the respective class in “process C” 42. Noteworthy about this “process C” 42 is that not just one presentation folder 17 is generated per customer but rather a plurality of presentation folders produced: customer-1-Brochure 1, customer-1-Brochure 2, customer-1-Brochure N. This ultimately gives the salesperson from the telephone directory publisher who calls on the customer the option of which of the customer brochures 17 he/she will actually use during the discussion. In generating the presentation folder, not only does Step 16 comprise the actual printing of individualized customer brochures 17 but they are also classified according to predefined rules, and which information based on which evaluation is printed on the presentation folder at which template location is actually registered and saved. In the system's steady state, only one individualized printed product is ideally needed per target customer. It should also be noted that generated presentation folders will also be stored electronically.

After having described the general operational sequence of the method above, the individual aspects of the present invention will now be addressed in greater detail. The above-cited rules as used in Steps 14 and 16 can take different priorities into account when generating the customer brochures. Different market and product strategies of the telephone directory provider can be considered here. Predefined super ordinate rules for a specific sales campaign could be considered. Same might concern, for example, the size of the ads to be sold or the color options for an ad or other parameters essential to designing individual ads for a telephone directory. In an economically disadvantaged area, individual discounts associated with certain ad sizes could also be proposed. Or, on the other hand, should the publisher launch a new product line (e.g. cellular phone), he would want his sales force to focus on this new product. This can be taken into account when generating an evaluation of the individualized data in Step 14. These changed evaluation rules effects different content being provided within the presentation folder templates when generating the individualized printed products or the customer-specific brochures in Step 16.

When generating the presentation folders or the customer-specific brochures in Step 16, consideration is paid to the fact that the customer is pitched not just one ad type but rather each customer brochure can contain at least two alternative proposals for at least two different individual ads, in particular of different sizes, and thus also contain price differences. The customer does not see both ad alternatives at first, because the special form to the presentation folder prevents the two ad types from being visible at the same time. Sales efforts can thus first be concentrated on selling the higher-value ad and only when that does not work does the salesperson still have the opportunity to present the alternative offer. It is also possible to have a split into a color ad and a less expensive black-and-white ad of the same size. Other combinations are also readily conceivable. Important to notice is that all these dependencies are rule based.

Apart from the ad proposals as mentioned above, the customer brochure templates can contain other fields for printing information. These might comprise, for example: the original data sources, general sales-supporting materials of the publisher, specific selling propositions, other publisher offerings, the rules according to which the ad proposals are generated, as well as targeted script guidelines for the sales staff. Even the script guidelines shall be individually adopted. If, for example, the customer has always run a small black-and-white ad in the past and the proposal seeks to feature a large-sized color ad in the future, the script guidelines should precisely advance the appropriate arguments. For example, it may be possible that a specific customer's previous presence was under-represented in comparison to his direct competitors. This would be the case when the customer previously ran small black-and-white ads while his three most important competitors were running large-scale colors ads. Because all of this information is available in database 121 stored in storage unit 73 the generation of these guidelines can be done automatically and rule based.

The following will discuss the self-learning characteristics to the method, which requires a computer system for its realization. Reference is made here to Step 18 as depicted in FIG. 2: “capture of success parameter(s) and processing for modification of evaluation rules.” Reference is also made to the components of the inventive system according to FIG. 1.

The essential variables in the computer-executed method are: all customer-relevant data, customer classes, which essentially represent prototype classes of model customers, valuation rules, templates for generating the printed products, the actual brochures as well as data about salespeople's preferences. At the end of a campaign, information is then provided as to which salesperson was able to sell which customer brochure and at which price. The campaign success parameters are collected. This information is also saved in the system as part of the method for subsequent processing. Storage can be done in database 121. The Step 18 processing comprises an analysis of the customer situation, represented by the totality of data available for a specific customer, the use of a specific customer brochure, salesperson specific data, as well as other parameters crucial to the campaign. The results from this analysis are typically saved in database tables. Other forms of saving the data are also conceivable. A graphic representation of the results shows an experienced campaign manager whether the valuation criteria, necessary for the evaluation of the presentation folders in Step 14, needs to be adjusted and whether other focal points must be defined when generating an evaluation in a subsequent campaign such that the prototype classes are reformulated and a different allocation of customer data 15 follows.

On the other hand, the tabular results can also lead to a direct influencing of Steps 14 and 16. Conceivable here, for example, is the automatic rejecting of specific predefined printing templates which are replaced by more successful ones. The determination rules of the system are preferably based on comparisons with previous campaigns. In this context, successful means that there is a higher probability of a sale being made. Additionally, conceivable is a reassigning of the target customer-relevant information from database 121 to the templates of printed products 17. It is possible for the sequence of the arguments to be sorted not in ascending order but in descending order of importance. Other feasible automated adjustment rules comprises a modified color selection for per individual pages of the templates for the presentation folder, a larger or smaller number of presentation folders for a customer from among which the salesperson can choose the selecting of a different template, etc. One skilled in the art can hereby conceive of any number of different possible combinations.

A new cycle of the method with the feedback information from the previous cycle is represented by the dotted line from “Stop” 19 to “Start” 11 in FIG. 2.

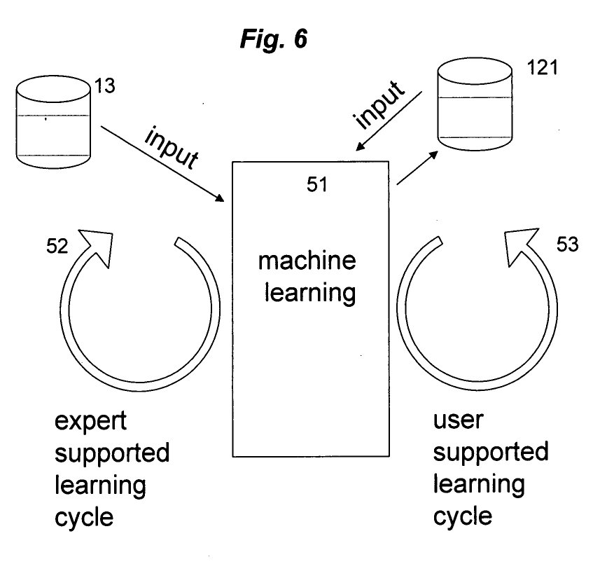

The proposed method provides dual optimization, respectively learning possibilities. On the one hand, the above-described analysis allows an expert to modify the valuation rules for creating the customer classes while, on the other hand, the system which itself executes the method based on the information fed back to it from sales processes can optimize same optimized for a salesperson and a customer. These circumstances are depicted in FIG. 6, whereby the abstract learning process 51 is divided into an expert-supported learning cycle 52 and a use-supported learning cycle 53. The expert-supported learning cycle thereby relates to the defining of rules for forming the different prototype classes and template assignment. The use-supported learning cycle on the other hand relates to the usage of the presentation folders during the sales process. The automatic modification to the visual appearance presentation folders illustrates a self-optimizing process which, in the best case scenario, always leads to the customer deciding in favor of the larger ad. If, for example, it is determined over the course of several ad campaigns that a certain salesperson has the greatest selling success with predominantly one type of presentation folder, the salesperson will only be offered a smaller number—possibly even only one—of presentation folders per customer from the system-executed method. This approach in turn saves time and money on the campaign process. The data used during the learning process are taken from the data source on the one side and from the database 121 in the other hand. The access to database 121 is far more intensive because it contains already consolidated individualized data. The key point is that data in the database 121 are also modified based on the learning and optimization process. This is indicated by the arrow pointing from the machine learning 51 to the database 121.

The skilled person in the art would use known procedures for the self-optimization of the method on a computer system. This would include autoclassification systems, case-based reasoning, decision tree models, cluster analyses, statistical variance analyses as well as other analytical and optimizing procedures known to one skilled in the art.

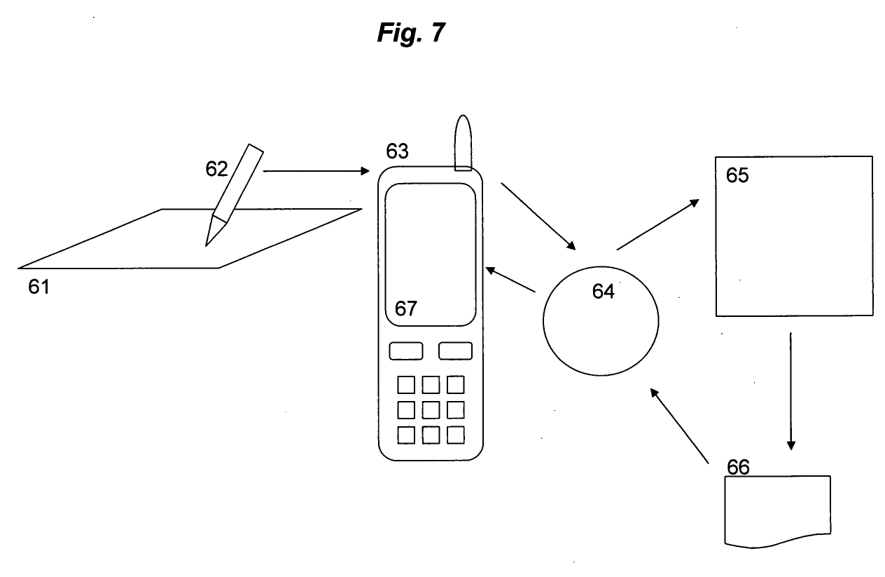

Another embodiment is depicted in FIG. 7. This embodiment relates primarily to a device-supported recording of data from the presentation folders. Usage in a practical environment could proceed as follows: an individual printed product in the form of a promotional flyer is first created, for example to support the sales of ads for telephone business directories using the above-cited method. This flyer is used by a salesperson during a sales meeting with the customer. It could contain an offer, for example, and/or it could contain further questions to the customer in the form of a questionnaire. A combination of these two types of information is more the rule on such a flyer. Specific fields and pages are provided on the presentation folders 17 for recording the data. The salesperson takes notes on the presentation folder during the meeting with the customer, for example marking checkboxes to record the customer's individual parameters (e.g. company size, customer structure, sales, product range, etc.), or the salesperson jots down handwritten comments or additions. In doing so, the salesperson uses an intelligent handwriting and position detection device 62 which can detect which side of the presentation folder 17 is currently being written on and, in particular, what is being written on which part of the paper. To this end, the paper is provided with wholly specific background pixel information during printing. This background pixel information is expressed as a background pattern of dots which the eye perceives as only a light gray background color. At the same time, handwriting and position detection device 62 saves the entries being made on paper 17. In other words, all changes, notes and inscriptions made on flyer 17 are recorded and saved.

At the end of a recording cycle, the information stored in pen 62 (handwritten notes, information on which checkboxes have been checked, arrows pointing to printed elements, etc.) can be transmitted to a cellular phone 63 or other mobile communication device such as a wireless-enabled PDA (personal digital assistant) or other small computer. This is either done by touching a special “send field” on presentation folder 17, which interprets the tap as a send command, or by pressing a send key on pen 62. Other mechanisms which will trigger the sending of information from the pen to cell phone 63 are also conceivable. Transmission to cell phone 63 can ensue via wired or wireless methods. Transmission via Bluetooth or infrared lends itself are well known. A call is initiated over the mobile communications network 64 by cell phone 63. After connecting to a computing center, which is preferably where the program runs a process as described with reference to FIG. 2, the information received by pen 62 is transmitted from cell phone 63 to said computing center. An assignment is made in the computing center between the presentation folder 17, known to the database of the computing center, and the information received. In so doing, the information received can contain an identification of presentation folder 17, which can be incorporated into presentation folder 17 in the background pixel information. This increases the wealth of information related to a customer in the database. It is also possible to effect a new assignment of prototype classes and customer data. In addition, a new calculation could, for example, give rise to a new discount class or other new correlations important to a sales pitch which the salesperson can indicate to the customer as modified or customized offer options which had not previously been considered or printed on the presentation folder 17. This information about a new price or discount can be transmitted via communication unit 75, a mobile network to the portable communication device and be displayed on the display 67.

In place of recording new customer information, the ad customer can directly engage the salesperson in conversation about his/her individual ad proposals shown on the presentation folder 17. The customer could, for example, want to change the color design or font sizes or any other ad parameter by means of notes made by the salesperson with pen 62. Any change which can be made on normal print sheets (printing proofs) is conceivable. Alternatively, the customer could simply accept the ad proposal outright.

Since in this embodiment, the information is actually being fed back to the guiding system and the method-realizing computer system as the customer meeting is still going on, reactions can be made accordingly fast—in real-time.

Based on new information coming in from cell phone 63 and mobile communications network 64, a new proposal 66 or a new order confirmation 66 or a further alternative proposal 66 can be made to the customer. In so doing, it would be additionally conceivable for an editor to browse and assess the modified ad proposal, transmitted from the sales meeting to the computing center as described above, as to whether the modified ad proposal is feasible in relation to the desired changes. This information 66 from the computing center (e.g. new assignment of customer, new discount calculations, order confirmation, confirmation of ad changes, etc.) can then be automatically re-transmitted back through mobile communications network 64 to cell phone 63 of the salesperson having the meeting with the customer. The information important to the salesperson is depicted on display screen 67 of cell phone 63. Feasible transmission options are SMS, MMS, email (e.g. ASCII, HTML, XML) or other transmission protocols/representations for structured and unstructured messages over portable or wired communication networks. It could be printed locally using a second mobile printing unit 78.

In this way, by recording on a piece of paper (individual printed product/flyer 17), the salesperson receives details, information and, as applicable, order confirmations during the sales pitch without human intervention. The salesperson could then print out an order confirmation on a second printer unit 78 from the information from cell phone 63 such that he/she can immediately hand the customer the order confirmation on the ad or the like.

An example of a suitable presentation folder 17 would be the present Applicant's “Sales Aid” application PCT/EP2006/000416.

A handwriting and position detection device such as e.g. that from the Swedish firm Anoto can be used as electronic pen 62. The above-described interactive function between the paper provided with the background pixel information and the electronic pen is known as Anoto functionality.

Another more advance embodiment of the inventive guiding system and the associated method is enabled by a global positioning system 79 (GPS) being in communication contact with mobile communication unit 63. Other positioning devices are also possible (e.g.: the Galileo system). With this a road and address finding system could be integrated in to the guiding system and associated method. A given campaign might require for a single sales person to visit a series of customers/companies. The totality of all customers/companies to be visited has been determined during the selection process for a campaign and stored in the database 121. Meeting dates have also been planned for those customers/companies. Instead of taking the presentation folder with the address and looking on a map the sales person planning to do the visit could be guided by the GPS to the address of the next customer. Because the sequence of visits has been predetermined based on timing and location parameters the guiding system is aware of the next visit address. This way the sales person could be led from one customer to the next with his mobile communication unit in combination with the GPS 79. In case one customer visit is cancelled on short notice the guiding system in combination with the associated method could direct the sales person in his car to an alternative address without requiring a manual reprogramming of the GPS in the car. All relevant data could be downloaded with the mobile communication unit 63 (cell phone) into to connected GPS 79. This saves further time and expenses by reducing time needed to re-optimize a chosen route from customer to customer.

In order to further optimize the route and customer visit planning a specially folded route folder per sales man could be generated together with a series of presentation folder 17 individually per customer. All together could be inserted into a box that serves the sales man as his “logistic center”. It contains the presentation folders and the route folder. The route folder could preferably be made of six business letter sized pages including a map of the territory with included numbered customer addresses and a list of customers with required details like account name, phone number, contact name, target revenue, meeting date and time, and other relevant data to a special campaign. In addition, success ratings for the meetings per customer could be included. These success rate parameters could later be fed back into the guiding system using the associated method in step 18. However, it is also possible to capture this information using the PDA/mobile communication unit 63 after each customer visit. This way the guiding function of the guiding system could be enhanced in that a further route optimization can be applied, e.g.: by-pass proposals for traffic jams or other unplanned exceptions. It has also the advantage of not loosing any valuable information during the campaign.

Hence, a closed loop process is established helping the self-optimization of the method for the intentional guiding system.

In summary, a guiding system and an associated method has been proposed in order to enhance the systems currently used to run campaign. A computing center, mobile communication systems, global positioning system, handwriting and position detection devices, database technologies for information collection as well as evaluation, assessment and self-optimizing techniques combined with the automatic generation of presentation folders based on rules and customer classes have been combined to reduce the spending per campaign and to enhance the integration and usage of available technology components.

The method as presented is not limited to the selling of ads in business telephone directories. It is just as applicable for use during sales meetings in any number of other branches of industry. First and foremost to be additionally cited would be the financial services industry and the insurance industry. In principle, the method in accordance with the application can be used universally, wherever a salesperson is more or less required to provide personal consultation to a customer in order to customize an individual offer. This would also apply, for example, to the capital goods investment industry.

What is claimed is:

1. Guiding system for producing presentation folders comprising:
an information processing unit;
an information collection unit connected to said information processing unit for collecting data from at least one source;
an information storage unit connected to said information processing unit for storing collected and processed information;
a first printing unit connected to said information processing unit;
a communication unit connected to said information processing unit;
a handwriting and position detection device,
characterized in that
the information processing unit has a communication channel to the handwriting and position detection device via the communication unit.

2. The guiding system according to claim 1, comprising a terminal unit connected to said information processing unit for inputting and displaying information.

3. The guiding system according to claim 1, wherein said communication unit has communication capabilities for line based networks as well as access to mobile communication systems.

4. The guiding system according to claim 1, comprising further a mobile communication device.

5. The guiding system according to claim 4, wherein said mobile communication device is a mobile phone.

6. The guiding system according to claim 4, wherein the mobile communication device has additional computational features to function as a personal digital assistant or said mobile communication device is integrated within a personal digital assistant.

7. The guiding system according to claim 4, comprising a second printing unit connectable to said communication unit.

8. The guiding system according to claim 4, wherein said communication channel from the processing unit to said handwriting and position detection device is established via said mobile communication device that has a wireless communication link to the handwriting and position detection device.

9. The guiding system according to claim 4, comprising a receiver for global positioning in communication contact with said communication device.

10. The guiding system according to claim 1, wherein said handwriting and position detection device is capable of recognizing its position on the presentation folder when used in a writing mode.

11. The guiding system according to claim 1, wherein the handwriting and position detection device is capable of recognizing its position based on printed marks.

12. The guiding system according to claim 4, wherein the handwriting and position detection device has communication capabilities to communicate with the mobile communication device.

13. Method of producing presentation folders by analyzing target person-relevant data utilizing machine learning comprising the steps of:
collecting and storing individualized data,
evaluating said individualized data based on a learning classification process as well as generating a at least one valuation parameter,
printing presentation folders based on said at least one valuation parameter.

14. Method according to claim 13, wherein said at least one valuation parameter of said individualized data comprises a step of creating at least one prototype class based on predefinable rules from said individualized data.

15. Method according to claim 13, wherein the step of evaluating said individualized data comprise the additional step of assigning target person-relevant data to said at least one prototype class created.

16. Method according to claim 13, wherein the step of collecting said individualized data comprises collecting structured and unstructured data and the two different types of data are also addressable in different data storages by means of at least one distinctive parameter.

17. Method according to claim 16, wherein said structured and unstructured data contain information from any of telephone books, industry data, historic data, regional data, competitor data, in particular competitor telephone directory advertisements, company indicators, credit rating data and/or advertising revenue.

18. Method according to claim 16, wherein said structured and unstructured data comprise printed and/or electronic media available offline and/or online.

19. Method according to claim 13, wherein said presentation folders contain printed information of said stored individualized data which takes a person's individual situation into account, wherein the printed information is generated according to modifiable rules and based on at least one priority valuation parameter and/or a printing template selection.

20. Method in accordance with claim 13, wherein the step of printing said presentation folder comprises generating of at least two alternative presentation folders.

21. Method according to claim 13, comprising a further step of detecting at least one success parameter and returning to the step of collecting individualized data.

22. Method according to claim 13, wherein the step of evaluating said individualized information comprises a step of machine learning drawing on the historic sequence of success parameters with respect to an acceptance of the presentation folders.

23. Method according to claim 13, comprising further the following steps:
detecting changed or additional data on said presentation folder made with a handwriting and position detection device which recognizes said detected data and store them in said handwriting and position detection device,
making said stored data available to said evaluation step or to the step of printing presentation folders and the generating of at least one return parameter.

24. Method according to claim 23, wherein the step of detecting changed or additional data with said handwriting and position detection device is based on marks provided as background on said presentation folder.

25. Method in accordance with claim 23, wherein said step of making stored data available to said evaluation step or to said step of printing presentation folders is done my means of a mobile communication device.

26. Method in accordance with claim 23, wherein said step of generating at least one return parameter comprises transmitting said at least one return parameter to a mobile communication device and displaying said at least one parameter on a display of said mobile communication device.

27. Computer program product with executable code for execution of said method according to claim 13 on a guiding system.

28. Computer readable medium for a computer program product according to claim 27.
